(19) United States
(12) Patent Application Publication
(10) Pub. No.: US 2023/0150407 A1
(43) Pub. Date: May 18, 2023

(54) PROTECTIVE COVER ASSEMBLY

(71) Applicant: Aubrey Lewis, Newnan, GA (US)

(72) Inventor: Aubrey Lewis, Newnan, GA (US)

(21) Appl. No.: 17/986,862

(22) Filed: Nov. 14, 2022

Related U.S. Application Data
(60) Provisional application No. 63/278,625, filed on Nov. 12, 2021.

(51) Int. Cl. B60N 2/60

(52) U.S. Cl. CPC B60N 2/6036; B60N 2/6027

(57) ABSTRACT

A protective cover assembly for at least temporarily covering a vehicle seat, chair or other occupiable furniture. The protective cover assembly includes a containment component and a retaining component. The containment component houses a protective material in a compacted or collapsed configuration and the retaining component provides removable engagement of the protective cover assembly to the seat to be covered. The protective material is deployable from the containment component to an expanded configuration to cover one or more portions of the seat as desired.

### CROSS-REFERENCE TO RELATED APPLICATION

This application claims the benefit of U.S. Provisional Patent Application Ser. No. 63/278,625 filed Nov. 12, 2021, the entirety of which is hereby incorporated herein by reference for all purposes.

### TECHNICAL FIELD

The present invention relates generally to the field of coverings and protection apparatuses, and more particularly to coverings and protection apparatuses for chairs, seats, vehicle components and assemblies and the like.

### SUMMARY

In example embodiments, the present invention provides a protective cover assembly for covering at least a portion of a vehicle seat. A protective material is deployable from the assembly and configured to provide a protective barrier about at least a portion of the vehicle seat. In example embodiments, a containment component houses the protective material which is deployable therefrom to cover one or more portions of the vehicle seat. The protective material provides a barrier between an occupant and the vehicle seat.

In one aspect, the present invention relates to protective cover assembly for a vehicle seat including a containment component, an attachment component and a retaining component. In example embodiments, the attachment component is configured for releasably connecting the containment component to the retaining component. In example embodiments, the containment component includes a housing including an interior volume, the interior volume being occupied by a protective material, the protective material being in a collapsed configuration within the interior volume of the housing. In example embodiments, the attachment component includes a one or more releasable coupling members or components so as to allow for removable attachment of the containment component with the retaining component.

In example embodiments, the retaining component includes one or more components configured to releasably connect the cover assembly to at least a portion of the vehicle seat. In example embodiments, the containment component further includes an opening formed along at least a portion of the housing for providing access to the interior volume, the opening permitting the protective material to be accessible such that the same can be deployed therefrom. In example embodiments, the protective material, when deployed from the housing, is expanded from the collapsed configuration to an expanded configuration. In example embodiments, once the protective material is in the expanded configuration, portions thereof are fitted about portions of the vehicle seat as desired, to provide at least one layer of protection thereon. In example embodiments, the protective material includes a sheet material or other desired material reconfigurable between a compacted state in the collapsed configuration and an expanded. In example embodiments, the sheet material is an impermeable plastic material.

In another aspect, the invention relates to a temporary seat cover including a containment component, an attachment component, and a retaining component. The containment component includes a housing defining an interior volume, which is occupied by a protective material in its compacted state. The protective material is deployable therefrom so as to provide fitting engagement with the seat and provide a barrier between the seat and an occupant sitting therein or otherwise occupying the seat. The retaining component is configured for removable attachment to at least a portion of the seat, and the attachment component provides removable coupling engagement of the containment component with the retaining component.

In example embodiments, the protective material is an impermeable plastic sheet or bag. In example embodiments, the protective material is scented. Is example embodiments, the protective material is unscented. In example embodiments, the protective material is sized and shaped to provide for fitting engagement with the seat.

In another aspect, the present invention relates to a protective cover assembly including a containment component and a retaining component. The containment component includes an interior volume at least partially occupied by a compacted protective material having a substantially small form factor. The retaining component includes one or more engagement members for releasably connecting the containment component to a vehicle seat, wherein the protective material is deployable from the containment component and expandable for fitting around at least a portion of the vehicle seat.

In example embodiments, the protective cover assembly further includes an attachment component for removable attachment of the containment component with the retaining component. In example embodiments, the containment component is disposable, and wherein the attachment portion provides for disengagement of the containment component and deployed protective material after its use. In example embodiments, the containment component is reusable by the insertion of an unused and compacted protective material. In example embodiments, the protective material includes an impermeable plastic sheet material. In example embodiments, the plastic sheet material is scented. In example embodiments, the plastic sheet material includes indicia and/or graphics and branding printed thereon.

In yet another example embodiment, the present invention relates to a method of protecting a vehicle seat. The method includes providing a vehicle seat; providing a protective cover assembly, the protective cover assembly including a containment component and a retaining component, the containment component including a compacted protective material contained therein, the retaining component configured for removable engagement with at least a portion of the vehicle seat such that the containment component is removably attached thereto; deploying the protective material from the containment component such that the protective material transitions from a compacted configuration to an expanded configuration; and wrapping or covering the vehicle seat with the protective material.

In example embodiments, the protective material includes an impermeable plastic sheet material.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a front view of a vehicle seat having a protective cover assembly removably connected thereto according to an example embodiment of the present invention.

FIG. 2 is a perspective view of the protective cover assembly of FIG. 1.

FIG. 3 is a front view of the protective cover assembly of FIG. 2.

FIG. 4 is a side view of the vehicle seat of FIG. 1, showing the protective material deployed from a portion of the cover assembly.

FIG. 5 is a side vide of the vehicle seat of FIG. 4, showing the protective material wrapped around at least a portion of the vehicle seat.

FIG. 6 is a side view of a protective cover assembly according to another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

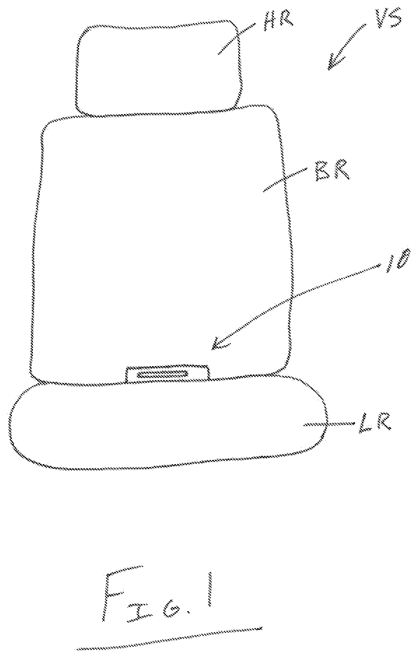

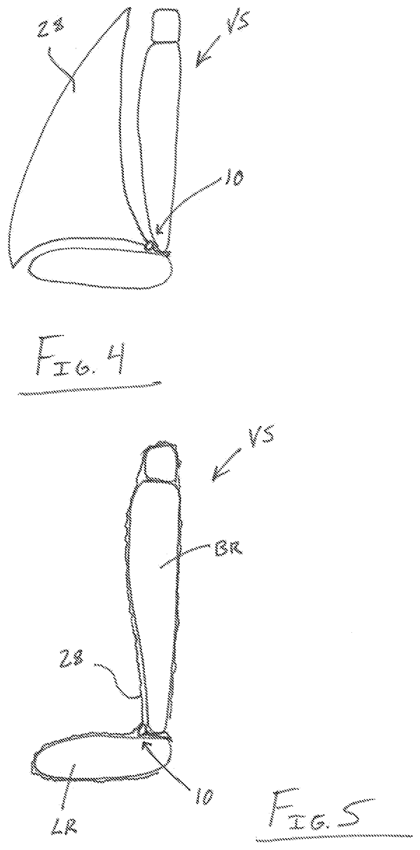

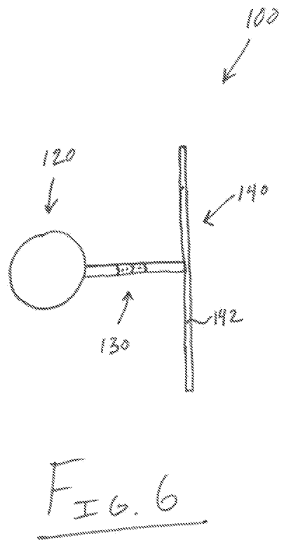

With reference now to the drawing figures, wherein like reference numbers represent corresponding parts throughout the several views, FIGS. 1-5 show a protective cover assembly 10 for providing removable attachment to a vehicle seat VS, for example, which can be deployed from a collapsed or stored configuration and erected or expanded to a deployed configuration such that at least one protective material or sheet component 28 covers at least a portion of the vehicle seat VS as desired. Once the cover is deployed and covering the vehicle seat as desired, a user or occupant sitting in the seat now has a barrier between them and the portion of the vehicle seat it's covering. For example, as will be described in greater detail below, the protective material can be applied to substantially the entirety of the vehicle seat as depicted in FIGS. 4-5, or for example, can be configured to be applied to only a portion of the vehicle seat, for example, such as the leg rest portion LR, the back rest portion BR, and/or the head rest portion HR.

For example, during such situations where the occupant of the vehicle seat is dirty, wet or otherwise in a state or condition substantially likely to damage or alter the state or condition of the vehicle seat when sitting therein or thereon for some period of time, the protective material provides a sufficient barrier against such an occurrence, and thus, the vehicle seat remains protected and undamaged despite the occupant's condition being substantially prone to causing such damage to occur. Furthermore, in some situations a user's clothing such as denim jeans or colored pants, when contacting the vehicle's seat while being worn by the occupant, can cause at least a portion of the dye therefrom to become absorbed within a portion of the vehicle seat (e.g., typically a non-black leather), and thus requires expensive professional services to clean and remove the markings from the vehicle seat VS. Similarly, the opposite could likewise be true in some situations, for example, wherein the leather of the vehicle seat could possibly stain the occupant's clothing, and thus, the protective material can be deployed to cover at least a desired portion of the vehicle's seat to provide a barrier between the two.

In other example embodiments, it may be desired to cover at least one portion of a vehicle seat VH with a protective layer, regardless of whether the occupant is in a condition likely to cause damage to the vehicle seat. For example, according to some example embodiments, complementary cover assemblies 10 could be provided as an additional component to a vehicle's service and/or maintenance, for example, to show additional care and provide even further protection for the owner of the vehicle, for example, especially when a mechanic or other service member or technician is briefly occupying the vehicle's seat.

Referring to FIGS. 1 and 4-5, the protective cover assembly 10 is generally removably connected to a portion of the vehicle seat VS that's generally near the intersection of where the leg rest portion LR and the back rest portion BR meet or join each other. As depicted, the protective material 28 remains compacted in a collapsed configuration within the protective cover assembly 10, and when desired, can be erected or expanded to a deployed configuration (see FIG. 4). Thereafter, the protective material 28 can be fitted around any desired portions of the vehicle seat VS. As shown in FIG. 5, the protective material is configured to cover at least the entirety of the surfaces of the vehicle seat VS that could come close to contacting the occupant during the use thereof. For example, the protective material is depicted to be substantially taught against the leg rest portion LR, back rest portion BR and head rest portion HR.

In example embodiments, the protective material 28 can be configured to provide for tight-fitting engagement with the vehicle seat, for example, whether the protective material itself comprise characteristics beneficial to fitting tightly around one or more portions of the vehicle seat VS, or for example, whether one or more additional features are added or incorporated in the material 28, the assembly 10, the vehicle seat VS, or otherwise incorporated therewith to provide for generally maintaining attachment and tautness of the protective material against the one or more desired portions of the vehicle seat VS. For example, according to some example embodiments, the protective material 28 is generally laminated, welded, sewn or otherwise shaped and formed to provide adequate and fitting engagement against the vehicle seat VS. According to one example embodiment, the protective material 28 can comprise a draw string incorporated therewith, for example, for physically tensioning an outer portion of the protective material therearound the vehicle seat VS as desired.

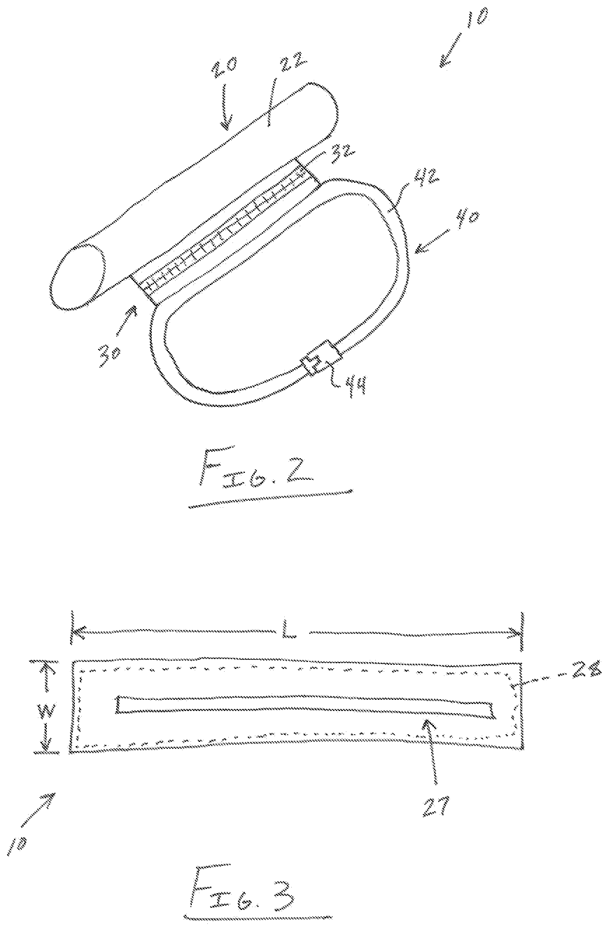

FIGS. 2-3 show the protective cover assembly 10 in greater detail. In example embodiments, the protective cover assembly 10 comprises a containment component 20, an attachment component 30 and a retaining component 40. In example embodiments, the containment component 20 comprises a housing 22 comprising an interior volume and an access opening 27. In example embodiments, the protective material 28 is configured to be compacted and retained within the housing 22 (e.g., the collapsed configuration), for example such that at least a portion of the interior volume thereof is occupied by the protective material 28. In example embodiments, the access opening is configured to permit the protective material to be drawn or deployed therefrom (e.g., the expanded configuration), for example, to cover one or more desired portions of the vehicle seat VS. In example embodiments, the housing 22 is generally cylindrical or tube-like and comprises a length L of between about 2-6 inches and a width of between about 0.5-4 inches. According to one example embodiment, the length L is about 4 inches and the width is about 0.75 inches. Optionally, the shape, size, form, construction, material(s), configuration of the housing, and the length L and width W can be chosen as desired. Further optional, the access opening can be configured as desired, and for example, a pull tab or other component can be configured for grasping by the user or occupant to cause deployment of the protective material 28 from the collapsed configuration.

In example embodiments, the housing 22 is constructed from one or more sheet materials, for example, textiles like a polyester blend, cotton or leather of any desired color or pattern, for example which can be adapted to match a vehicle's interior. In alternate example embodiments, other materials (or combinations thereof) can be provided as desired. In some example embodiments, the housing can be formed from natural materials, unnatural materials, plastics, polymers, fabrics or other desired materials and/or combinations thereof. In example embodiments, the access opening 27 is configured to comprise a closure such that the opening can be selectively opened or closed as desired. According to one example embodiment, the closure comprises hook and loop material. In other example embodiments, the closure can comprise one or more clips, clasps, connectors and/or other interengagement components as desired.

The attachment component 30 provides for releasable engagement of the containment component 20 with the retaining component 40. In example embodiments, the attachment component comprises a plurality of interengagement teeth 32, for example, such as a zipper, which can permit easy attachment and detachment of the containment component 20 to/from the retaining component 40. For example, with the retaining component 40 removably connected to at least a portion of the vehicle seat VS, the containment component 20 can be easily attached or detached by simply engaging or disengaging the attachment component 30. According to one example embodiment, the containment component 20 comprises a first portion of the attachment component 30 and the retaining component 40 comprises a second portion of the attachment component 30, for example, wherein the first and second portions of the attachment component 30 provide complementary and removable engagement. According to some example embodiments, the attachment component 30 comprises hook and loop material, magnetic components, couplings, connectors and/or other desired components for providing removable engagement of the containment component 20 with the retaining component 40.

The retaining component 40 comprises an elastic band 42, and a connector or other coupling is provided with the elastic band 42 to permit easily connecting or disconnecting the same such that the retaining component 40 is removably connectable to one or more portions of the vehicle seat VS. According to example embodiments, the retaining component 40 is configured to generally stretch and wrap around one or more portions of the vehicle seat VS to retain the containment component 20 in the vehicle seat VS. According to one example embodiment, the elastic band 42 comprises a pinch closure 44 or other couplings so as to permit selective engagement/disengagement of the elastic band 42. According to some example embodiments, the retaining component 40 comprises one or more features and/or components to permit permanent attachment of the second portion of the attachment portion 30 thereto. Optionally, the retaining component 40 can comprise various other coupling components, attachment members, clasps, engagement components or other members capable of providing removable engagement with the vehicle seat VS so as to maintain the containment component 20 at a desired location relative to the vehicle seat VS.

In example embodiments, a user, occupant or vehicle owner can install a protective cover assembly 10 by removably connecting the retaining component 40 to the vehicle seat VS. In example embodiments, the protective cover assembly 10 is generally placed atop the leg rest portion LR near close proximity to the back rest portion BR (see FIGS. 1 and 4-5). The retaining component 40 is removably connected to one or more portions of the vehicle seat VS, for example, wherein the elastic band 42 passes through and/or around one or more passageways, openings or components of the vehicle seat VS and reconnects by the closure 44. Thereafter, when it is desired to protect the vehicle seat VS, the protective material 28 is drawn from the access opening 27 to a deployed or expanded configuration (see FIG. 4) and securely fitted about one or more portions of the vehicle seat VS. As such, the protective material 28 provides a protective barrier to shield the occupant from directly contacting the vehicle seat VS, and thus, the vehicle seat VS remains shielded from being damaged or otherwise altered due to the occupant or condition of the occupant while occupying the vehicle seat VS.

After the occupant no longer needs or requires the vehicle seat VS to be protected or covered, the occupant can easily remove the containment component 20 and deployed protective material 28 from the vehicle seat VS, for example, by disengaging the first and second portions of the attachment portion 30. According to some example embodiments, the containment component 20 is intended for a single use, and thus is discarded after being used and removed from the vehicle seat VS. As such, another containment component 20 comprising the protective material 28 contained within the interior volume of the housing 22 can be removably connected to the retainment component 40 for future use. According to other example embodiments, the containment component 20 is reusable wherein unused and compacted or wrapped protective material 28 is refilled or reloaded within the interior volume of the housing 22.

In example embodiments, the protective material 28 is preferably configured to be capable of comprising a reconfigurable form factor, for example, being capable of maintain a compacted or wrapped state in the collapsed configuration while being retained within the interior volume of the housing 22, and for example, being capable of deploying to an expanded or unwrapped state in the expanded or deployed configuration. The protective material 28 can be formed from a thin impermeable sheet material, for example, a plastic or the like. The protective material 28 can optionally be formed from various other materials or combinations thereof, for example, materials which can comprise a small form factor when compacted and a substantially large form factor when expanded. As described above, the protective material 28 may be laminated, welded, sewn or otherwise shaped and formed to provide adequate and fitting engagement against the vehicle seat VS. Thus, according to some example embodiments, plastic sheet material is generally cut to size and assembled or otherwise formed to complement the size and shape of a vehicle seat VS. In some example embodiments, a single plastic sheet is shaped and formed to provide the complementary shape. In another example embodiment, two or more plastic sheets can be connected together so as to form the complementary shape.

According to other example embodiments, the protective material 28 can comprise a draw string incorporated therewith, for example, for physically tensioning an outer portion of the protective material therearound the vehicle seat VS as desired. According to yet another example embodiment, one or more additional attachment or retaining components can be provided as desired, for example, to provide for engagement of the protective material 28 with the vehicle seat VS. According to example embodiments, the protective material 28 may not be entirely impermeable. According to some example embodiments, the protective material 28 can be scented to comprise a desired scent, or for example can be unscented. According to some example embodiments, the protective material 28 can be configured to comprise indicia or other desired graphics or images thereon as desired.

FIG. 6 shows a cover assembly 100 according to another example embodiment of the present invention. In example embodiments, the protective cover assembly 100 is substantially similar to the cover assembly 10, for example, comprising a containment component 120, an attachment component 130 and a retaining component 140. According to example embodiments, the retaining component 140, rather than comprising an elastic band 42, comprises a shim or wedge component 142. The wedge component 142 is configured to pass through a slit or gap that's defined between the leg rest portion LR and the back rest portion BR of the vehicle seat VS, for example, wherein its size and shape prevent the withdrawal therefrom, for example, since it's oriented generally perpendicular to the orientation of the slit defined between the leg rest portion LR and back rest portion BR of the vehicle seat VS. The wedge component 142 can be formed from a plastic material, a natural material and/or various materials as desired. In example embodiments, the wedge component 142 comprises at least some amount of rigidity to prevent it from being unintentionally deformed and pulled through the slit of the vehicle seat VS.

According to additional example embodiments, the protective cover assemblies 10, 100 can preferably be constructed and configured as desired. Preferably, the protective cover assemblies 10, 100 are configured to permit a protective material to be deployed from a compacted configuration to an expanded configuration and cover at least a portion of a vehicle seat VS. The assemblies 10, 100 can be configured for removable engagement with any desired portion of a vehicle seat VS, and for example, be of the type for single one-time use, or for example, permit multiple uses thereof such that the protective material is reconfigurable between the collapsed and expanded configurations. According to additional example embodiments, the protective cover assemblies 10, 100 can be configured for use with any type of vehicle seat VS, a bench-style vehicle seat, or for example various other seats, chairs or other furniture where a protective barrier is desired to be placed thereon before being occupied. According to some example embodiments, the protective cover assemblies 10, 100 can be configured such that the attachment component 30, 130 is not needed, for example, wherein the retaining component 40, 140 is connected to the containment component 20, 120, for example, wherein either the containment component 20, 120 can be reloaded with the same protective material for multiple uses, or for example, a new compacted protective material refill can be inserted within the interior volume of the housing of the containment component 20, 120. In other example embodiments, the entire assembly 10, 100 is disposable after a single use.

According to another example embodiment of the present invention, the present invention relates to a method of protecting a vehicle seat. In example embodiments, the method comprises providing a vehicle seat; providing a protective cover assembly, the protective cover assembly comprising a containment component and a retaining component, the containment component comprising a compacted protective material contained therein, the retaining component configured for removable engagement with at least a portion of the vehicle seat such that the containment component is removably attached thereto; deploying the protective material from the containment component such that the protective material transitions from a compacted configuration to an expanded configuration; and wrapping or covering the vehicle seat with the protective material.

While the invention has been described with reference to example embodiments, it will be understood by those skilled in the art that a variety of modifications, additions and deletions are within the scope of the invention, as defined by the following claims.

What is claimed is:

1. A cover assembly for a vehicle seat, the cover assembly comprising:
a containment component;
an attachment component; and
a retaining component.

2. The cover assembly of claim 1, wherein the attachment component is configured for releasably connecting the containment component to the retaining component.

3. The cover assembly of claim 1, wherein the containment component comprises a housing comprising an interior volume, the interior volume being occupied by a protective material, the protective material being in a collapsed configuration within the interior volume of the housing.

4. The cover assembly of claim 2, wherein the attachment component comprises a one or more releasable coupling members or components so as to allow for removable attachment of the containment component with the retaining component.

5. The cover assembly of claim 1, wherein the retaining component comprises one or more components configured to releasably connect the cover assembly to at least a portion of the vehicle seat.

6. The cover assembly of claim 3, wherein the containment component further comprises an opening formed along at least a portion of the housing for providing access to the interior volume, the opening permitting the protective material to be accessible such that the same can be deployed therefrom.

7. The cover assembly of claim 6, wherein the protective material, when deployed from the housing, is expanded from the collapsed configuration to an expanded configuration.

8. The cover assembly of claim 7, wherein once the protective material is in the expanded configuration, portions thereof are fitted about portions of the vehicle seat as desired, to provide at least one layer of protection thereon.

9. The cover assembly of claim 3, wherein the protective material comprises a sheet material or other desired material reconfigurable between a compacted state in the collapsed configuration and an expanded.

10. The cover assembly of claim 9, wherein the protective material comprises plastic sheet material.

11. The cover assembly of claim 10, wherein the plastic sheet material is scented.

12. A protective cover assembly comprising a containment component and a retaining component, the containment component comprising an interior volume at least partially occupied by a compacted protective material comprising a substantially small form factor, the retaining component comprising one or more engagement members for releasably connecting the containment component to a vehicle seat, wherein the protective material is deployable from the containment component and expandable for fitting around at least a portion of the vehicle seat.

13. The protective cover of claim 12, further comprising an attachment component for removable attachment of the containment component with the retaining component.

14. The protective cover of claim 13, wherein the containment component is disposable, and wherein the attachment portion provides for disengagement of the containment component and deployed protective material after its use.

15. The protective cover of claim 12, wherein the containment component is reusable by the insertion of an unused and compacted protective material.

16. The protective cover of claim 12, wherein the protective material comprises an impermeable plastic sheet material.

17. The protective cover of claim 12, wherein the plastic sheet material is scented.

18. The protective cover of claim 17, wherein the plastic sheet material comprises indicia and/or graphics and branding printed thereon.

19. A method of protecting a vehicle seat, the method comprising:
providing a vehicle seat;
providing a protective cover assembly, the protective cover assembly comprising a containment component and a retaining component, the containment component comprising a compacted protective material contained therein, the retaining component configured for removable engagement with at least a portion of the vehicle seat such that the containment component is removably attached thereto;
deploying the protective material from the containment component such that the protective material transitions from a compacted configuration to an expanded configuration; and
wrapping or covering the vehicle seat with the protective material.

20. The method of claim 19, wherein the protective material comprises an impermeable plastic sheet material.
